(19) United States
(12) Patent Application Publication
(10) Pub. No.: US 2026/0339930 A1
(43) Pub. Date: Oct. 29, 2026

(54) METHODS FOR GENERATING IMPROVED STRUCTURED QUERY LANGUAGE (SQL) QUERIES RESPONSIVE TO NATURAL LANGUAGE INPUTS AND SYSTEMS THEREOF

(71) Applicant: Jones Lang LaSalle IP, Inc., Chicago, IL (US)

(72) Inventors: Or HILTCH, Tel Aviv (IL); Nir BERKO, Holon (IL); Surabhi GUPTA, Buffalo Grove, IL (US)

(21) Appl. No.: 19/192,802

(22) Filed: Apr. 29, 2025

(51) Int. Cl. G06F 16/242; G06F 16/22; G06F 16/2455; G06F 16/334

(52) U.S. Cl. CPC G06F 16/243; G06F 16/2237; G06F 16/2455; G06F 16/3344

(57) ABSTRACT

Methods, non-transitory computer readable media, and conversational artificial intelligence (AI) systems are disclosed that generate improved structured query language (SQL) queries responsive to natural language inputs. In some examples, the disclosed technology populates a vector database with vector embeddings generated by applying an embedding model to tokens generated at least in part from values of cells of a SQL database. A token is then obtained based on a semantic similarity search of the vector database using a vector embedding generated from a natural language query using the embedding model. A large language model (LLM) is prompted to generate a SQL query based on the natural language query, at least a portion of a schema for the SQL database, and the token. The SQL query is executed against the SQL database to generate and return a result in response to the natural language query.

### FIELD

This technology generally relates to generating structured query language (SQL) database queries and, more particularly, to generating improved SQL queries from natural language queries using embedding and large language models to yield more accurate results to those natural language queries.

### BACKGROUND

Structured Query Language (SQL) databases are pervasive among organizations that require data storage capabilities. Currently, there are many use cases for generating SQL queries based on natural language. One prime use case is to enable retrieval of structured data from SQL-based enterprise databases in order to use the data as context for an artificial intelligence (AI) system as part of a real-time chat interaction. Conversational AI systems hosting chatbots or virtual agents are increasingly used in customer service and other types of deployments to receive and process natural language inputs, such as questions or queries, from users and return answers based on data extracted from storage, such as in SQL databases.

Thus, currently available software solutions leverage AI models to convert natural language queries to SQL queries that can be executed against SQL databases to extract responsive data. In order to perform such conversion from a user's question in a natural language format to a SQL statement that can be executed on a SQL database, one popular method is to provide a large language model (LLM) with the schema of the SQL database and example SQL queries, which the LLM can then use to generate specific SQL queries based on the natural language input.

Other current methods maintain symbolic representations of the data maintained in the SQL database and compile a SQL query based on mapping the user's natural language query to symbols in a semantic layer. However, all current methods of converting natural language inputs to SQL queries fail to generate sufficiently accurate SQL queries, including when users do not specify key element(s) needed to generate an accurate SQL query.

For example, suppose there is a conversational AI system in which a user can ask questions about investment funds managed as part of their firm's operations. In this example, there is a fund manager by the name of Laura Williams who works at the firm and manages several funds. Also in this example, the conversational AI system is supported by a backed SQL database with a table called “funds” with various columns, such as “country,” “fund_manager_name,” “fund_size,” and “fund_strategy.”

Accordingly, a user might ask the question: “What funds does Laura manage in Germany?” To respond to the user's natural language query, the conversational AI system may be configured to prompt an LLM with the schema of the database, one or more exemplary queries or conversions (e.g., “How many funds do we manage?”→“SELECT COUNT(*) from funds”), and an instruction to transform the user's natural language question to a SQL query.

In this example, there would be two problems with creating an accurate SQL query from this natural language question: (1) the database column country might use two-digit country codes (i.e., “DE” instead of “Germany”) and (2) the database column fund_manager_name may contain the full name of a person (e.g., “Laura Williams” instead of “Laura”). Thus, the conversational AI system may convert that natural language question to the “SELECT * from funds WHERE fund_manager_name=‘Laura’and country=‘Germany’” SQL query.

Since the user specified only “Laura” and “Germany” in their natural language question, there are no exact matches for in either of the corresponding databases columns and this generated SQL query will not yield any results when executed against the SQL database despite that database maintaining data that is responsive to the user's question. Thus, as this example makes clear, current conversational AI systems often fail to generate effective SQL queries from natural language inputs yielding deficient (e.g., incomplete or inaccurate) data extraction and response from SQL databases and limiting the efficacy and reliability of conversational AI systems.

### SUMMARY

In one example, a method for generating structured query language (SQL) queries is disclosed that is implemented by a conversational artificial intelligence (AI) system and includes populating a vector database with vector embeddings generated by applying an embedding model to tokens generated at least in part from values of cells of a SQL database. A token is obtained based on a semantic similarity search of the vector database using a vector embedding generated from a natural language query using the embedding model. A large language model (LLM) is prompted to generate a SQL query based on the natural language query, at least a portion of a schema for the SQL database, and the token. The SQL query is then executed against the SQL database to generate and return a result in response to the natural language query.

In another example, a conversational AI system is disclosed that includes memory including instructions stored thereon for generating structured query language (SQL) queries and one or more processors configured to execute the stored instructions to populate a vector database with vector embeddings generated by applying an embedding model to tokens generated at least in part from values of cells of a SQL database. A token is obtained based on a semantic similarity search of the vector database using a vector embedding generated from a natural language query using the embedding model. An LLM is prompted to generate a SQL query based on the natural language query, at least a portion of a schema for the SQL database, and the token. The SQL query is then executed against the SQL database to generate and return a result in response to the natural language query.

In yet another example, a non-transitory computer readable media is disclosed that has instructions for generating SQL queries stored thereon and includes executable code that, when executed by one or more processors, causes the processors to populate a vector database with vector embeddings generated by applying an embedding model to tokens generated at least in part from values of cells of a SQL database. A token is obtained based on a semantic similarity search of the vector database using a vector embedding generated from a natural language query using the embedding model. An LLM is prompted to generate a SQL query based on the natural language query, at least a portion of a schema for the SQL database, and the token. The SQL query is then executed against the SQL database to generate and return a result in response to the natural language query.

This technology provides a number of advantages including methods, non-transitory computer readable media, and conversational AI systems that leverage vector embeddings of SQL database schema and contents and semantic similarity searches of the vector embeddings to improve the quality of SQL queries generated by LLMs from natural language inputs. By embedding a natural language query in real-time and comparing the resulting vector with a vector database containing vector embeddings, matching similarity results will yield data that can be leveraged to improve the generated SQL query and the accuracy of the data retrieved based on that query. Thus, this technology solves a problem that only exists in computer storage networks and improves conversational AI and SQL database technology.

### BRIEF DESCRIPTION OF THE DRAWINGS

FIG. 1 is a block diagram of an exemplary network environment with a conversational artificial intelligence (AI) system;

FIG. 2 is a block diagram of an exemplary conversational AI system;

FIG. 3 is a flowchart of an exemplary method for generating structured query language (SQL) database queries from natural language inputs; and

FIG. 4 is a flow diagram of an exemplary method for generating SQL database queries from natural language inputs.

### DETAILED DESCRIPTION

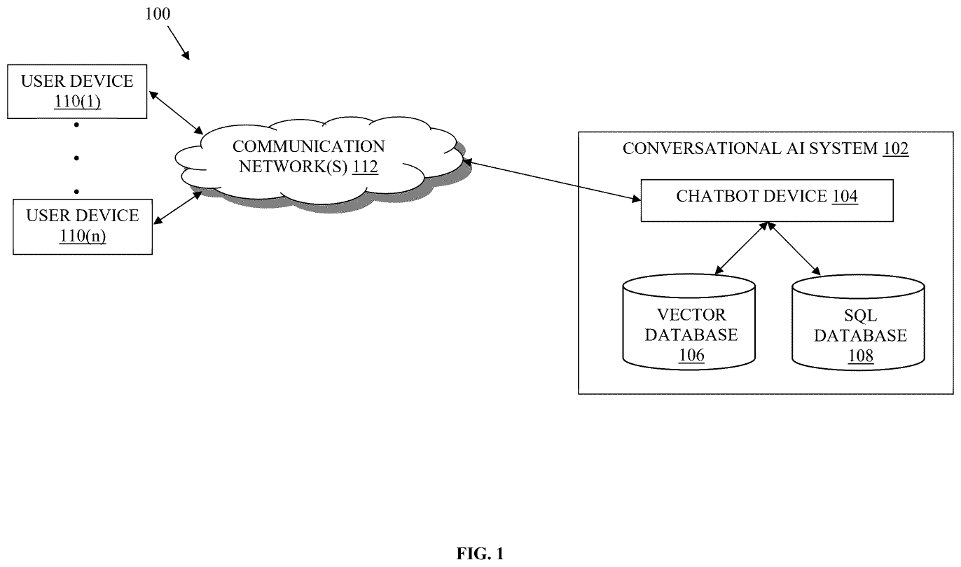

Referring to FIG. 1, an exemplary network environment 100 is illustrated that includes a conversational AI system 102, with a chatbot device 104, vector database 106, and SQL database 108, coupled to user devices 110(1)-100(n) via communication network(s) 112. The network environment 100 may include other network devices such as one or more routers or switches, for example, which are known in the art and thus will not be described herein. This technology has a number of advantages including methods, non-transitory computer readable media, and conversational AI systems that provide improved SQL query generation from natural language inputs by leveraging vector embeddings of SQL database 108 schema and data in a vector database 106, and a similarity search of the vector database 106, to yield more accurate data extract from the SQL database 108.

In this example, the user devices 110(1)-110(n), chatbot device 104, vector database 106, and SQL database 108 are disclosed in FIG. 1 as dedicated hardware devices. However, one or more of user devices 110(1)-110(n), chatbot device 104, vector database 106, or SQL database 108 can also be implemented in software within one or more other devices in the network environment 100. As one example, the vector database 106, as well as any of its components or applications, can be implemented as software executing on the chatbot device 104, and many other permutations and types of implementations and network topologies can also be used in other examples.

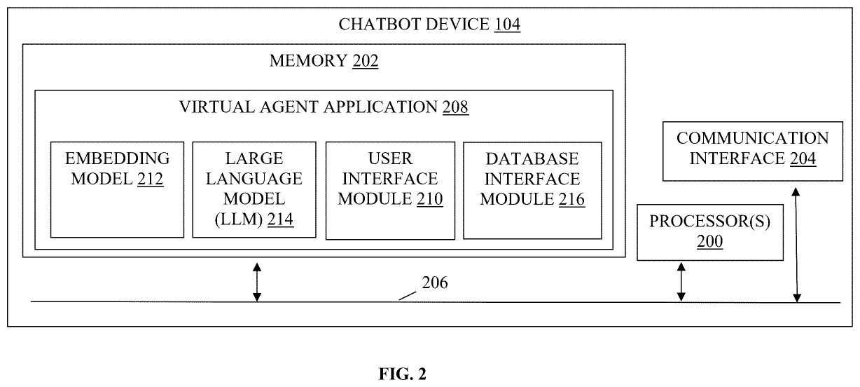

Referring to FIGS. 1-2, the chatbot device 104 may perform any number of functions, including providing graphical user interfaces (GUIs) to the user devices 110(1)-110(n) for ingestion of natural language inputs (e.g., queries) and return of responsive data from the SQL database 108, and other functions as described and illustrated in detail below. The chatbot device 104 in this example includes processor(s) 200, memory 202, and a communication interface 204, which are coupled together by a bus 206, although the chatbot device 104 can include other types or numbers of elements in other configurations.

The processor(s) 200 of the chatbot device 104 may execute programmed instructions stored in the memory 202 of the chatbot device 104 for any number of the functions described and illustrated herein. The processor(s) 200 may include one or more processing cores, one or more central processing units, and/or one or more graphics processing units, for example, although other types of processor(s) can also be used.

The memory 202 stores these programmed instructions for one or more aspects of the present technology as described and illustrated herein, although some or all of the programmed instructions could be stored elsewhere. A variety of different types of memory storage devices, such as random-access memory (RAM), read only memory (ROM), hard disk, solid state drives, flash memory, or other computer readable medium which is read from and written to by a magnetic, optical, or other reading and writing system that is coupled to the processor(s) 200, can be used for the memory 202.

Accordingly, the memory 202 can store applications that can include computer executable instructions that, when executed by the processor(s) 200, cause the chatbot device 104 to perform actions, such as to transmit, receive, or otherwise process network messages and requests and generate graphical interfaces and displays, for example, and to perform other actions described and illustrated below. The application(s) can be implemented as components of other applications, operating system extensions, and/or plugins, for example.

Further, the application(s) may be operative in a cloud-based computing environment with access provided via a software-as-a-service (Saas) model. The application(s) can be executed within or as virtual machine(s) or virtual server(s) that may be managed in a cloud-based computing environment. Also, the application(s), and even the chatbot device 104 itself, may be located in virtual server(s) running in a cloud-based computing environment rather than being tied to specific physical network computing devices.

In some examples, the memory 202 includes a virtual agent application 208 that includes a user interface module 210, an embedding model 212, a large language model (LLM) 214, and a database interface module 216. The user interface module 210 is configured to generate GUIs for receiving natural language queries from the user devices 110(1)-110(n). Accordingly, the user interface module 210 is effectively a front end module of the virtual agent application 208.

The embedding model 212 is configured to generate vector embeddings from the received natural language queries as well as the schema and contents of the SQL database 108. The virtual agent application 208 uses the database interface module 216 to store the vector embeddings generated from the schema and contents of the SQL database 108 in the vector database 106. In one example, the vector database 106 can be the Pinecone vector database available from Pinecone Systems, Inc. of San Francisco, California, which uses cosine similarity to evaluate the proximity of vectors, although other types of vector databases can also be used.

Additionally, the virtual agent application 208 uses the database interface module 216 to execute a semantic similarity search of the vector database 106 using the vector embedding generated from a natural language query, as explained in more detail below. In some examples, the embedding model 212 is the text-embedding-ada-002 model available from OpenAI, Inc. of San Francisco, California, although any other embedding model can be used in other examples.

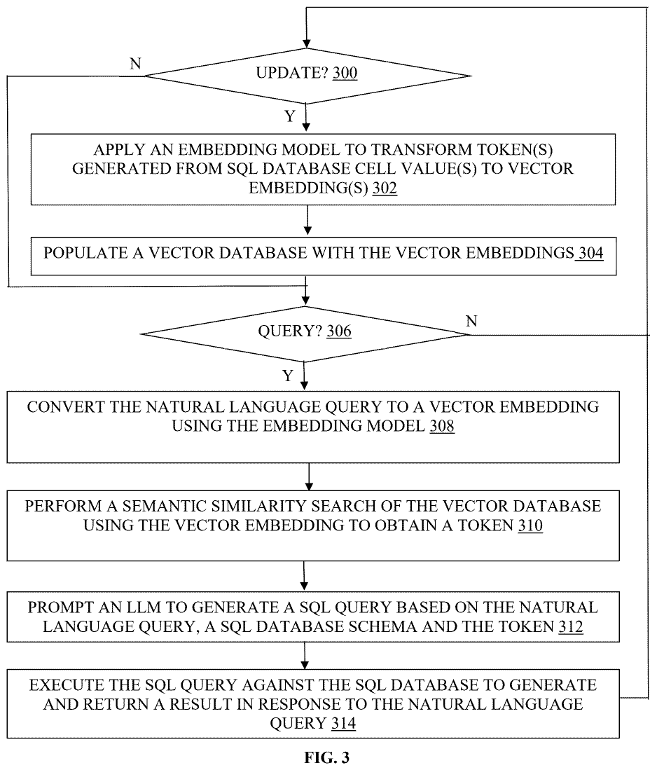

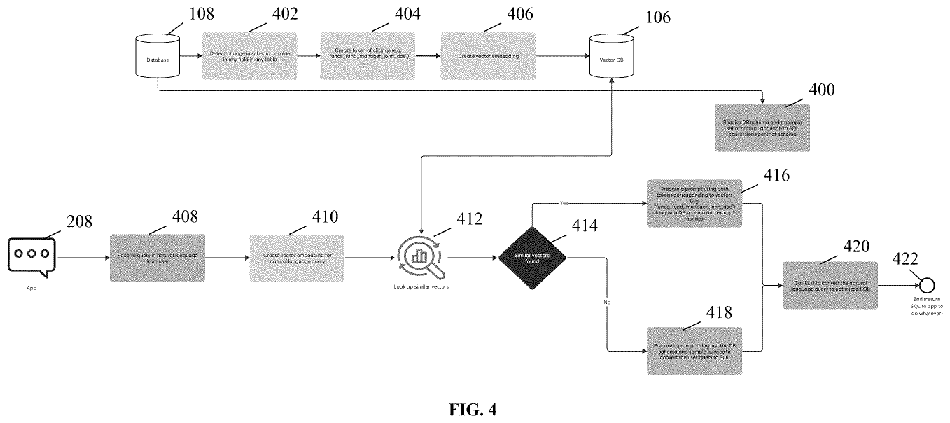

With a token returned from the vector database 106, the natural language query, and at least a portion of the schema of the SQL database 108, the virtual agent application 208 is configured to prompt the LLM 214 with an instruction to convert the natural language query to a SQL query. The virtual agent application 208 then uses the database interface module 216 to execute the generated SQL query against the SQL database 108 to generate a result, which is returned to one of the user devices 110(1)-110(n) via the user interface module 210. In some examples, the LLM 214 can be GPT-4 also available from OpenAI, Inc. of San Francisco, California, although any other LLM can be used in other examples. The operation of the virtual agent application 208 will be described and illustrated in more detail below with reference to FIGS. 3-4.

The communication interface 204 of the chatbot device 104 operatively couples and communicates between the chatbot device 104, user devices 110(1)-110(n), vector database 106, and SQL database 108, which are coupled together at least in part by the communication network(s) 112 in this particular example, although other types or numbers of communication networks or systems with other types or numbers of connections or configurations to other devices or elements can also be used. The communication network(s) 112 can include wide area network(s) (WAN(s)) and/or local area network(s) (LAN(s)), for example, and can use TCP/IP over Ethernet and industry-standard protocols, although other types or numbers of protocols or communication networks can be used. The communication network(s) 112 can employ any suitable interface mechanisms and network communication technologies including, for example, Ethernet-based Packet Data Networks (PDNs).

The chatbot device 104 in some examples can include a plurality of devices each having one or more processors (each processor with one or more processing cores) that implement one or more steps of this technology. In these examples, one or more of the devices can have a dedicated communication interface or memory. Alternatively, one or more of the devices can utilize the memory 202, communication interface 204, or other hardware or software components of one or more other devices included in the chatbot device 104. Additionally, one or more of the devices that together comprise the chatbot device 104 in other examples can be standalone devices or integrated with one or more other devices or apparatuses.

Each of the user devices 110(1)-110(n) of the network environment 100 in this example includes any type of computing device that can exchange network data, such as mobile, desktop, laptop, or tablet computing devices. Each of the user devices 110(1)-110(n) includes processor(s), memory, and a communication interface, which are coupled together by a bus or other communication link (not illustrated), although other numbers or types of components could also be used.

Each of the user devices 110(1)-110(n) may run interface applications, such as web browsers or standalone applications, which may provide an interface to communicate with the chatbot device 104 via the communication network(s) 112. Each of the user devices 110(1)-110(n) may further include a display device, such as a display screen or touchscreen, or an input device, such as a keyboard or mouse, for example (not shown).

Although the exemplary network environment 100 with the user devices 110(1)-110(n), chatbot device 104, vector database 106, SQL database 108, and communication network(s) 112 is described and illustrated herein, other types or numbers of systems, devices, components, or elements in other topologies can be used. It is to be understood that the systems of the examples described herein are for exemplary purposes, as many variations of the specific hardware and software used to implement the examples are possible, as will be appreciated by those skilled in the relevant art(s).

One or more of the components depicted in the network environment 100, such as the user devices 110(1)-110(n), chatbot device 104, vector database 106, or SQL database 108, for example, may be configured to operate as virtual instances on the same physical machine. In other words, one or more of the user devices 110(1)-110(n), chatbot device 104, vector database 106, or SQL database 108 may operate on the same physical device rather than as separate devices communicating through the communication network(s) 112. Additionally, there may be more or fewer user devices, chatbot devices, vector databases, or SQL databases than illustrated in FIG. 1.

The examples of this technology may also be embodied as one or more non-transitory computer readable media having instructions stored thereon, such as in the memory 202 of the chatbot device 104, for one or more aspects of the present technology, as described and illustrated by way of the examples herein. The instructions in some examples include executable code that, when executed by one or more processors, such as the processor(s) 200 of the chatbot device 104, cause the processors to carry out steps necessary to implement the methods of the examples of this technology that will now be described and illustrated herein.

Referring now to FIG. 3, a flowchart of an exemplary method for generating SQL database 108 queries from natural language inputs is illustrated. In step 300 in this example, the chatbot device 104 determines whether the SQL database 108 has just been initialized or, in a subsequent iteration, there has been an update to the SQL database 108.

In some examples, whenever the SQL database 108 is updated with respect to any portion of the schema (e.g., any update to a table or column name or type) or values of cells or records of the SQL database 108, the SQL database 108 (e.g., a database management system (DBMS) for the SQL database 108) may be configured to notify the virtual agent application 208 and thereby trigger a corresponding update to the vector database 106, which is explained with reference to steps 302-304. Accordingly, if the chatbot device 104 determines that there has been an update to the SQL database 108, then the Yes branch is taken to step 302.

In step 302, the chatbot device 104 applies the embedding model 212 to transform token(s) generated from the SQL database 108 cell value(s) to vector embeddings. More specifically, the chatbot device 104 can generate the token(s) associated with the updated schema or cell values based on table names of associated tables in the SQL database 108, column names of columns in those tables, and cell values of records within those columns. Accordingly, each token generated in step 302, from which the embedding model 212 generates vector embeddings, can include a table name, a column name, and a cell value in some examples.

Thus, upon initialization, the chatbot device 104 in some examples creates, for all tables in the SQL database 108, and for each cell in a particular table, a token of the form of a string: “%table_name%_%column_name%_%cell value%.” The chatbot device 104 then applies the embedding model 212 to each of the generated tokens to generate vector embeddings. Other types of tokens can also be generated in other examples having different SQL database 108 schemas and/or cell values. Continuing with the example explained above in which current technologies are deficient, the technology described and illustrated herein may generate vectors corresponding to “funds_fund_manager_name_Laura_Williams” and “funds_fund_country_DE.”

In step 304, the chatbot device 104 populates the vector database 106 with the vector embeddings generated in step 302. Thus, the vector database 106 is populated in this example with vector embeddings generated by applying the embedding model 212 to tokens generated at least in part from values of cells of the SQL database 108.

In iterations subsequent to initialization, the chatbot device 104 can repeat steps 302-304 for each cell impacted by or associated with the change to the SQL database 108 that triggered the update. Thus, the disclosed technology utilizes an embedding pipeline to continually update the vector database 106 responsive to changes to the SQL database 108. Optionally, the vector database 106 can also be maintained to remove embeddings that are no longer accurate as a result of the change to the SQL database 108. After populating the vector database 106 in step 304, or if the chatbot device 104 determines in step 300 that there has not been an updater to the SQL database 108 in the current iteration and the No branch is taken, then chatbot device 104 proceeds to step 306.

In step 306, the chatbot device 104 determines whether a query has been received, such as via a GUI provided by the user interface module 210 and from one of the user devices 110(1)-110(n). The query can be in a natural language format, such as “What funds does Laura manage in Germany?” in the example explained herein. While a natural language question or query is used in the examples described and illustrated herein, other types of natural language inputs can also be used in other examples.

If the chatbot device 104 determines that a query has not been received, then the No branch is taken back to step 300 and the chatbot device 104 effectively waits for an update to the SQL database 108 to be triggered or a query to be received. However, if the chatbot device 104 determines in step 306 that a query has been received, then the Yes branch is taken to step 308.

In step 308, the chatbot device 104 converts the natural language query to at least one vector embedding using the embedding model 212. In some examples, the same embedding model 212 is used in step 308 as was used in step 302 to transform the token(s) generated from the SQL database 108 cell value(s) to vector embedding(s). By using the same embedding model 212, subsequent semantic similarity searching may be more effective.

In step 310, the chatbot device 104 performs a semantic similarity search of the vector database 106, using the vector embedding generated in step 308 from the natural language query, to identify the most similar vector embedding(s) and obtain their corresponding clear-text representations (i.e., tokens). Continuing with the above example, the semantic similarity search of the vector database 106 in step 310 may yield the tokens (e.g., strings): “funds_fund_manager_name_Laura_Williams” and “funds_fund_country_DE.” As explained above, those tokens were generated from SQL database 108 cell values in step 302.

Thus, the chatbot device 104 in this example obtained the most similar vectors to the result of the vector embedding of the received natural language query (i.e., “What funds does Laura manage in Germany?”). The natural language query in this example is semantically similar to both the “funds_fund_manager_name_Laura_Williams” token (because the user asked about a fund manager called Laura) and to the “funds_fund_country_DE” token (because the user asked about funds in Germany, and the embedding model 212 represents DE and Germany in close proximity in the vector space).

In step 312, the chatbot device 104 prompts the LLM 214 to instruct the LLM 214 to generate a SQL query based on the received natural language query (e.g., “What funds does Laura manage in Germany?”), at least a portion (e.g., all) of a schema for the SQL database 108 (e.g., a table called “funds” with columns “country,” “fund_manager_name,” “fund_size,” and “fund_strategy”), and the token(s) obtained in step 310 (e.g., “funds_fund_manager_name_Laura_Williams” and “funds_fund_country_DE”). Other information can also be included in the prompt, such as exemplary SQL queries of the SQL database 108.

Based on the prompt, the LLM 214 of the chatbot device 104 in this example would generate a resulting SQL query of “SELECT * from funds WHERE fund_manager_name=‘Laura Williams’ and country=‘DE’,” which would find corresponding values in the SQL database 108 and provide an accurate result in response to execution of the SQL query, instead of a SQL query of “SELECT * from funds WHERE fund_manager_name=‘Laura’ and country=‘Germany’,” which would not have any matching values in the SQL database 108 and would not provide any results in response to execution of the SQL query. In this example, the SQL query generated in step 312 includes cell values (i.e., “Laura Williams” and “DE”) extracted from the tokens generated in step 310 in place of other values (i.e., “Laura” and “Germany,” respectively) extracted from the natural language query.

In step 314, the chatbot device 104 uses the database interface module 216 to execute the SQL query generated by the LLM 214 in step 312 against the SQL database 108 to generate and return a result in response to the natural language query received in step 306. The response can be returned via a GUI generated and provided by the user interface module 210 to one of the user devices 110(1)-110(n) from which the natural language query was received in step 306. Subsequent to generating and returning the result, the chatbot device 104 in this example proceeds back to step 300 and effectively waits for an update to the SQL database 108 or another natural language query to be received. In other examples, one or more of steps 300-314 can be performed in parallel and/or in a different order.

Referring now to FIG. 4, a flow diagram of an exemplary method for generating SQL database 108 queries from natural language inputs is illustrated. In step 400 in this example, the chatbot device 104 obtains a schema for the SQL database 108 and a sample set of natural language to SQL conversions in accordance with that schema. The schema can be obtained from a DBMS or server host of the SQL database 108 or via the interrogation of the SQL database 108 by the database interface module 216, for example.

In step 402, the chatbot device 104 detects a change in the schema or cell or record value in any field in any table of the SQL database 108. The change can be a change to a column or table name, a change of a cell value, or an addition of a table, for example. Upon initiation of the conversational AI system 102, every cell value of the SQL database 108 is considered to correspond to an update.

In step 404, the chatbot device 104 creates a token associated with the change, which can be a string, for example. In the example illustrated in FIG. 4, the created token is “funds_fund_manager_john_doe,” which indicates that in the “funds” table and “fund manager” column, the new or updated fund manager name is “john doe.”

In step 406, the chatbot device 104 applies the embedding model 212 to create a vector embedding from the token created in step 404. The chatbot device 104 then stores the created vector embedding in the vector database 106.

In step 408, the virtual agent application 208 executed by the chatbot device 104 receives a query in a natural language format from a user of one of the user devices 110(1)-110(n). The natural language query can be received via a GUI provided by the chatbot device 104 via the user interface module 210 in response to a request for the GUI from the one of the user devices 110(1)-110(n), for example.

In step 410, the chatbot device 104 creates a vector embedding for the natural language query, optionally using the same embedding model 212 as used to create the vector embedding of the token in step 406. With the vector embedding, in step 412, the chatbot device 104 performs a semantic similarity search of the vector database 106 to identify similar vector embeddings and associated clear-text token(s).

In step 414, the chatbot device 104 determines whether any similar vectors (e.g., vector embeddings or associated tokens) were found based on the semantic similarity search of the vector database 106 in step 412 according to the vector embedding created for the natural language query in step 410. If the chatbot device 104 determines in step 414 that one or more similar vectors were found based on the semantic similarity search, then the Yes branch is taken to step 416.

In step 416, the chatbot device 104 prepares a prompt using token(s) corresponding to the similar vector(s) (e.g., the “funds_fund_manager_john_doe” token previously created in step 404), the SQL database 108 schema, the natural language query, and optionally one or more exemplary SQL queries. However, referring back to step 414, if the chatbot device 104 determines that no similar vectors are found based on the semantic similarity search of the vector database 106, then the No branch is taken to step 418.

In step 418, the chatbot device 104 prepares a prompt using just the schema of the SQL database 108, the natural language query, and optionally one or more sample SQL queries.

Accordingly, the prompt created in step 418 does not include any tokens as opposed to the prompt prepared in step 416.

In step 420, the chatbot device 104 calls the LLM 214 using the prompt prepared in step 416 or the prompt prepared in step 418. The call to the LLM 214 can include the prepared prompt and a request to convert the natural language query to a SQL query that, in the case of the prompt prepared in accordance with step 416, may be an optimized SQL query that is more likely to retrieve responsive data from the SQL database 108.

In step 422, the chatbot device 104 returns the generated SQL query from the LLM 214 to the virtual agent application 208 so that the virtual agent application 208 can execute the SQL query against the SQL database 108 to generate and return a response to the natural language query to the querying one of the user devices 110(1)-110(n).

As described and illustrated by way of the examples herein, this technology advantageously provides a mechanism that obtains a natural language query and a generated SQL query as input, runs the natural language query through a vector embedding model, and retrieves similar vectors along with their corresponding clear-text representation, to be used as data to improve the generated SQL query. Specifically, this technology enables systems that need to generate SQL statements or queries based on user questions or other input in natural language to do so with improved accuracy by generating or fixing the SQL queries based on SQL database 108 data against which the SQL queries are to be executed. Accordingly, database, data storage and management, and conversational AI systems are significantly improved with the technology described and illustrated herein.

Having thus described the basic concept of the invention, it will be rather apparent to those skilled in the art that the foregoing detailed disclosure is intended to be presented by way of example only and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

1. A method for generating structured query language (SQL) queries, the method implemented by a conversational artificial intelligence (AI) system and comprising:
populating a vector database with vector embeddings generated by applying an embedding model to tokens each comprising a value of a cell of a SQL database and a portion of a schema of the SQL database associated with the cell;
obtaining a token based on a semantic similarity search of the vector database using a vector embedding generated from a natural language query using the embedding model, wherein the token comprises a clear-text representation of one of the vector embeddings comprising one of the cell values and one of the portions of the schema;
prompting a large language model (LLM) to generate a SQL query based on the natural language query, the schema, and the token; and
executing the SQL query against the SQL database to generate and return a result in response to the natural language query.

2. The method of claim 1, wherein the portion of the schema of the SQL database comprises a table name of a table of the SQL database and a column name of a column of the SQL database.

3. The method of claim 1, wherein the SQL query comprises a cell value extracted from the token in place of another value extracted from the natural language query.

4. The method of claim 1, further comprising updating the vector database with one or more vector embeddings generated by applying the embedding model to one or more tokens generated based at least in part on other values of other cells of the SQL database impacted by a determined change to at least one of the SQL database schema or at least one of the cell values.

5. The method of claim 1, further comprising prompting the LLM to generate the SQL query further based on one or more exemplary SQL queries of the SQL database.

6. The method of claim 1, further comprising prompting the LLM to generate the SQL query based on the natural language query and the at least a portion of the SQL database schema, and without the token, when a result of the semantic similarity search indicates that no similar tokens were found in the vector database.

7. A conversational artificial intelligence (AI) system, comprising memory having instructions stored thereon for generating structured query language (SQL) queries and one or more processors coupled to the memory and configured to execute the stored instructions to:
populate a vector database with vector embeddings generated by applying an embedding model to tokens each comprising a value of a cell of a SQL database and a portion of a schema of the SQL database associated with the cell;
obtain a token based on a semantic similarity search of the vector database using a vector embedding generated from a natural language query using the embedding model, wherein the token comprises a clear-text representation of one of the vector embeddings comprising one of the cell values and one of the portions of the schema;
prompt a large language model (LLM) to generate a SQL query based on the natural language query, the schema, and the token; and
execute the SQL query against the SQL database to generate and return a result in response to the natural language query.

8. The conversational AI system of claim 7, wherein the portion of the schema of the SQL database comprises a table name of a table of the SQL database and a column name of a column of the SQL database.

9. The conversational AI system of claim 7, wherein the SQL query comprises a cell value extracted from the token in place of another value extracted from the natural language query.

10. The conversational AI system of claim 7, wherein the processors are further configured to execute the stored instructions to update the vector database with one or more vector embeddings generated by applying the embedding model to one or more tokens generated based at least in part on other values of other cells of the SQL database impacted by a determined change to at least one of the SQL database schema or at least one of the cell values.

11. The conversational AI system of claim 7, wherein the processors are further configured to execute the stored instructions to prompt the LLM to generate the SQL query further based on one or more exemplary SQL queries of the SQL database.

12. The conversational AI system of claim 7, wherein the processors are further configured to execute the stored instructions to prompt the LLM to generate the SQL query based on the natural language query and the at least a portion of the SQL database schema, and without the token, when a result of the semantic similarity search indicates that no similar tokens were found in the vector database.

13. A non-transitory computer readable medium having stored thereon instructions for generating structured query language (SQL) queries comprising executable code that, when executed by one or more processors, causes the processors to:
populate a vector database with vector embeddings generated by applying an embedding model to tokens each comprising a value of a cell of a SQL database and a portion of a schema of the SQL database associated with the cell;
obtain a token based on a semantic similarity search of the vector database using a vector embedding generated from a natural language query using the embedding model, wherein the token comprises a clear-text representation of one of the vector embeddings comprising one of the cell values and one of the portions of the schema;
prompt a large language model (LLM) to generate a SQL query based on the natural language query, the schema, and the token; and
execute the SQL query against the SQL database to generate and return a result in response to the natural language query.

14. The non-transitory computer readable medium of claim 13, wherein the portion of the schema of the SQL database comprises a table name of a table of the SQL database and a column name of a column of the SQL database.

15. The non-transitory computer readable medium of claim 13, wherein the SQL query comprises a cell value extracted from the token in place of another value extracted from the natural language query.

16. The non-transitory computer readable medium of claim 13, wherein the executable code, when executed by the processors, further causes the processors to update the vector database with one or more vector embeddings generated by applying the embedding model to one or more tokens generated based at least in part on other values of other cells of the SQL database impacted by a determined change to at least one of the SQL database schema or at least one of the cell values.

17. The non-transitory computer readable medium of claim 13, wherein the executable code, when executed by the processors, further causes the processors to prompt the LLM to generate the SQL query further based on one or more exemplary SQL queries of the SQL database.

18. The non-transitory computer readable medium of claim 13, wherein the executable code, when executed by the processors, further causes the processors to prompt the LLM to generate the SQL query based on the natural language query and the at least a portion of the SQL database schema, and without the token, when a result of the semantic similarity search indicates that no similar tokens were found in the vector database.
